(19) United States
(12) Patent Application Publication
(10) Pub. No.: US 2020/0039534 A1
(43) Pub. Date: Feb. 6, 2020

(54) SYSTEMS AND METHODS FOR UNIFIED END POINT MANAGEMENT FOR VEHICLES

(71) Applicant: Citrix Systems, Inc., Fort Lauderdale, FL (US)

(72) Inventors: Marcos A. DiPietro, Pietro, Fort Lauderdale, FL (US); Rohit Singh, Fort Lauderdale, FL (US); Luis Atencio, Fort Lauderdale, FL (US); Ashish Gujarathi, Fort Lauderdale, FL (US)

(21) Appl. No.: 16/052,994

(22) Filed: Aug. 2, 2018

(51) Int. Cl. B60W 50/08; H04L 29/08; B60W 50/00

(52) U.S. Cl. CPC B60W 50/085; H04L 67/12; B60W 50/087; B60W 2540/28; B60W 2550/12; B60W 2550/20; B60W 50/0098

(57) ABSTRACT

Systems and methods for operating a vehicle. The methods comprise: receiving, by a vehicle on-board computing device of the vehicle, an enterprise-wide policy that is applicable to a plurality of vehicles and defines at least one action to operate each of the plurality of vehicles in response to an event; adjusting, by the vehicle on-board computing devices, one or more local vehicle policies of the vehicle based on the received enterprise-wide policy (the local vehicle policies being executable by the vehicle on-board computing device to operate the vehicle); and executing, by the vehicle on-board computing devices, the adjusted one or more vehicle policies to operate the vehicle so that the vehicle executes the at least one action as defined by the enterprise-wide policy in response to an occurrence of the event.

### BACKGROUND

### Statement of the Technical Field

The present disclosure relates generally to on-board computers of vehicles. More particularly, the present disclosure relates to implementing systems and methods for unified end point management for vehicles.

### Description of the Related Art

Modern day vehicles have at least one on-board computer and have internet/satellite connectivity. The software running on these on-board computers monitor and/or control operations of the vehicles.

### SUMMARY

The present disclosure concerns implementing systems and methods for operating a vehicle. The methods comprise: receiving, by a vehicle on-board computing device of the vehicle, an enterprise-wide policy that is applicable to a plurality of vehicles and defines at least one action to operate each of the plurality of vehicles in response to an event; adjusting, by the vehicle on-board computing device, one or more local vehicle policies of the vehicle based on the received enterprise-wide policy (the local vehicle policies are executable by the vehicle on-board computing device to operate the vehicle); and executing, by the vehicle on-board computing device, the adjusted one or more vehicle policies to operate the vehicle so that the vehicle executes the at least one action as defined by the enterprise-wide policies in response to an occurrence of the event. The vehicle's behavior is controlled or limited based on vehicle related information obtained from a plurality of vehicle sensors. The executing can comprise: overriding a static policy for controlling operations of the vehicle; and/or overriding user control of the vehicle.

In some scenarios, the enterprise-wide policy is administered by a remote computing device that is configured to communicate with the vehicles. The methods also comprise concurrently reconfiguring vehicle related parameters of multiple vehicles in a fleet of vehicles based on receipt of the enterprise-wide policy by each of the multiple vehicles in the fleet of vehicles. The vehicle related parameters comprise vehicle drive parameters and auxiliary device parameters. The auxiliary device parameters comprise parameters for a radio, a display, a camera, a location device, or a Short Range Communications (“SRC”) enable device.

In those or other scenarios, the enterprise-wide policy is dynamically changed in response to a trigger event. The trigger event comprises an expiration of a period of time, a change in enterprise requirements, a change in enterprise procedures, a change in enterprise guidelines, a change in enterprise goals, a vehicles arrival or return to a given facility, a change in traffic conditions, a change in weather, a change in criminal activity, a change in a geographic area's crime or safety level, a change in a vehicle use, or a change in a vehicle operator.

In those or yet other scenarios, the enterprise-wide policy is a first enterprise-wide policy. A second enterprise-wide policy is dynamically changed based on at least one of (a) historical information about vehicle behavior, use or location, (b) machine-learned patterns of vehicle operations or use, (c), vehicle traffic information, and (d) safety information.

### BRIEF DESCRIPTION OF THE DRAWINGS

The present solution will be described with reference to the following drawing figures, in which like numerals represent like items throughout the figures.

FIG. 1 is an illustration of an illustrative system.

FIG. 2 is an illustration of an illustrative architecture for a vehicle.

FIG. 3 is an illustration of an illustrative computing device.

FIG. 4 provides a message flow for the system shown in FIG. 1.

FIG. 5 provides a flow diagram of an illustrative method for operating a fleet of vehicles.

FIG. 6 provides a flow diagram of an illustrative method for operating a vehicle.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present solution may be embodied in other specific forms without departing from its spirit or essential characteristics. The described embodiments are to be considered in all respects only as illustrative and not restrictive. The scope of the present solution is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present solution should be or are in any single embodiment of the present solution. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One skilled in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

Reference throughout this specification to “one embodiment”, “an embodiment”, or similar language means that a particular feature, structure, or characteristic described in connection with the indicated embodiment is included in at least one embodiment of the present solution. Thus, the phrases “in one embodiment”, “in an embodiment”, and similar language throughout this specification may, but do not necessarily, all refer to the same embodiment.

As used in this document, the singular form “a”, “an”, and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to”.

The present solution concerns systems and methods for applying a uniform set of enterprise-wide policies for vehicles or other devices. The enterprise-wide policies comprise enterprise level policies implementing enterprise-wide requirements, procedures, guidelines and/or goals. The term “requirement”, as used herein, means a thing that is needed such as necessary condition. The term “procedure”, as used herein, means an established way of doing something. The term “guideline”, as used herein, means a general rule or principle. The term “goal”, as used herein, means a desired result. The present solution overcomes many drawbacks of conventional vehicle based systems, such as not being able to modify factory set static policies of a vehicle and/or not being able to concurrently set enterprise-wide policies for vehicles in a fleet of vehicles. For example, the present solution provides an enterprise system in which an enterprise is able to control or limit the behavior of their vehicles in a dynamic and customizable manner which is different than that specified at the factory during the vehicle's manufacture. No such solution exists for allowing a centralized configuration of a fleet of vehicles.

The present solution has many novel features. For example, the present solution provides a centralized configuration for a fleet of vehicles (e.g., vehicle settings, radio/media configuration, Global Positioning System (“GPS”) configuration, etc.). The present solution also provides centralized monitoring for the fleet of vehicles. The centralized monitoring can be used to collect driving data (e.g., location, speed, seat-belt usage, braking habits, etc.) and maintenance data (e.g., oil/fuel levels, tire pressure, etc.) to determine actions to be taken (e.g., driver training, limit vehicle speed, vehicle maintenance, etc.). These centralized features of the present solution have many advantages. For example, these centralized features (1) reduce latency of transmitting information and making policy changes (i.e., data can be collected at the vehicle, and the agent can make changes locally to achieve goals of the enterprise-wide policy based on that data with no transmission of data back to the administrator which can be time consuming), (2) reduces the amount of information transmitted along networks thereby minimizes impact on network and system resource, and (3) allow for the collection of data and the generation of policy changes close to the source of data collection (i.e., local policies can be modified based on local data to improve efficiencies and effectiveness while achieving enterprise goals).

The present solution also has an architecture with a distributive nature and benefits. For example, having the agent close to data sources reduces network congestion to update received local policies at the vehicle (i.e., local policies can be updated based on local data while achieving the goals of received enterprise-wide policies without having to communicate information back to the network administrator).

The present solution is achieved by installing or having a pre-installed software agent on the vehicles. This software agent then can synchronize a vehicle policy with a centralized policy server securely over a network (e.g., the Internet or World Wide Web). An administrator then can set enterprise level policies through an administration management console. The enterprise level policies are passed down and enforced by the software agent. For example, the present solution may implement the following enterprise level policies.
Confine a vehicle to a given area or route. If the vehicle leaves the area, then the policy enforcement code would shut the vehicle down.
Limit the speed of a vehicle. This could also be a geo-dependent setting where different speed limits could be set based on the location of the vehicle.
Hours of operation. This prevents a vehicle from running outside of hours of operation.
Altitude. This controls the flight altitude of unmanned devices (e.g., drones).

Below are some use cases for the above enterprise level policies.
Any company with a large fleet of vehicles may use such features to negotiate lower insurance rates and make sure that their employees are not abusing of the company owned vehicles.
Any company that picks-up/drops-off money or any other valuables may implement an enterprise level policy to prevent their fleet from going near dangerous areas so that the possibility of robberies is reduced.
Any company that lends a vehicle to its employee for commute purposes may use the above policies to control where the vehicle is and how it should behave if the employee were to drive passed a certain perimeter area, if the employee were to exceed certain speed limits, or if the employee was to leave the company.

Additionally, any information that is available to the policy enforcement agent can automatically be collected and sent to the centralized policy server to be consumed and exposed via Application Programming Interfaces (“APIs”). As a federal requirement, trucks and other cargo vehicles must keep electronic activity logs. These electronic activity logs can also be fetched and sent to the proper reporting system.

A rental car's customization can be reset when a rental period ends (e.g., a radio station, GPS destinations, a media center language, etc.). Additionally, a driver's driving preference and subscriptions (e.g., Pandora, SiriusXM, etc.) can be automatically synchronized to the vehicle (s)he is presently driving. A passenger's preferences can be similarly synchronized.

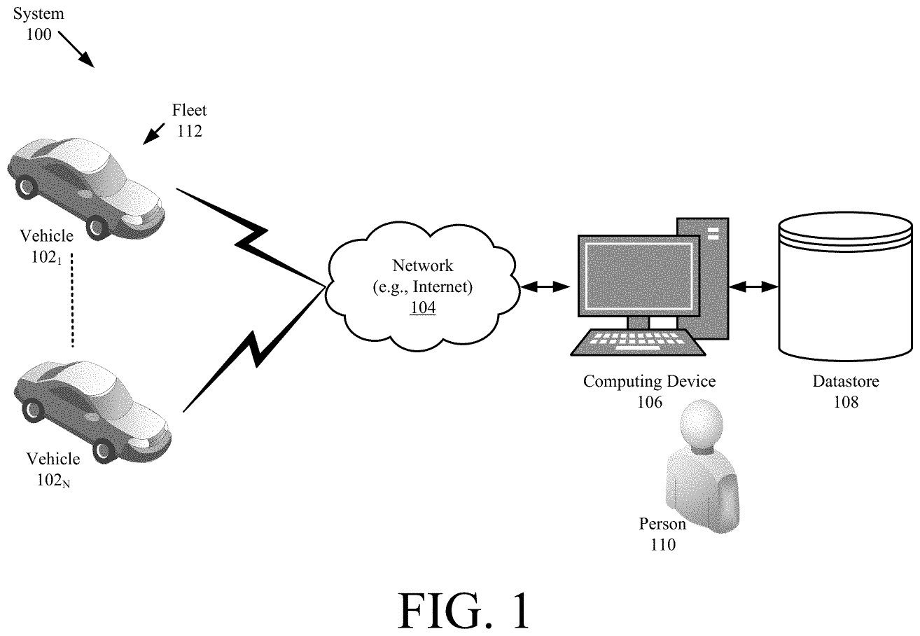

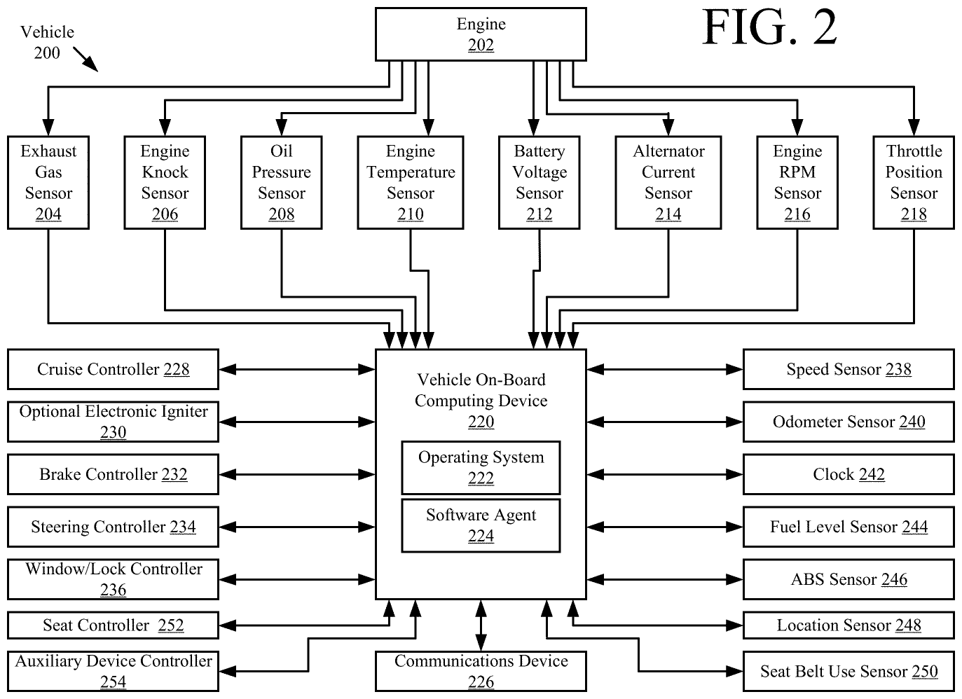

Referring now to FIG. 1, there is provided an illustration of an illustrative system 100. System 100 comprises a plurality of vehicles 102₁, . . . , 102_{N}, a network 104, a computing device 106 and a datastore 108. Any vehicle can be used herein without limitation. For example, the vehicles include, but are not limited to, cars, trucks, scooters, motorcycles, boats, Unmanned Ground Vehicles (“UGVs”), and/or Unmanned Aerial Vehicles (“UAVs”). An illustrative system architecture for the vehicles 102₁, . . . , 102_{N} will be discussed below in relation to FIG. 2.

The vehicles 102₁, . . . , 102_{N} are generally configured to communicate data to and from a remote computing device 106 via the network 104 (e.g., the Internet or World Wide Web). In this way, each of the vehicles is registered with the system so that the vehicle's operations can be monitored and controlled at an enterprise level (e.g., so that the needs of a business organization are satisfied rather than the needs of individual uses of the vehicles). This registration can be achieved by exchanging messages between the vehicles and the remote computing device 106 to sign-up or join to the enterprise-wide control service. This registration also allows operations of all vehicles in a fleet 112 to be concurrently or simultaneously monitored and controlled at an enterprise level. In some scenarios, the vehicles can be grouped into two or more sub-groups arbitrarily or based on some criteria (e.g., the type of vehicle use or type of vehicle (e.g., hybrid cars vs. non-hybrid cars)). Accordingly, operations of the vehicles in a given sub-group can be concurrently or simultaneously monitored and controlled at an enterprise level.

The computing device 106 facilitates the centralized configuration of vehicle related parameters and policies. The vehicle related parameters include, but are not limited to, vehicle drive parameters (e.g., speed) and auxiliary device parameters. The auxiliary devices can include, but are not limited to, a radio, a display, a camera, a location device, and a Short Range Communication (“SRC”) enabled device (e.g., a smart phone). In this regard, the auxiliary device parameters include, but are not limited to, radio parameters (e.g., channels), media parameters (e.g., camera parameters and/or display parameters), and/or location tracking parameters (e.g., GPS device parameters).

The policies include enterprise level policies implementing enterprise-wide requirements, procedures, guidelines and/or goals. Each enterprise level policy contains a policy for one or more vehicles that can be administered by an administrator 110 of the computing device 106. An illustrative policy is to take Y action in response to an occurrence of X event. For example, a policy states that: driving is to be prevented until a seat belt is being used by all passengers in the a vehicle; the vehicle is to be turned off when the vehicle leaves a given geographic area or enters into a given geographic area (e.g., identified by zip code); or the vehicle should take an alternative route to a destination that avoids certain geographic areas. The present solution is not limited to the particulars of this example.

In some scenarios, the enterprise level policies are dynamically changed in response to a trigger event. The trigger event includes, but is not limited to, an expiration of a period of time, a change in enterprise requirements, a change in enterprise procedures, a change in enterprise guidelines, a change in enterprise goals, vehicle(s) arrival or return to a given facility, a change in traffic conditions, a change in weather, a change in criminal activity, a change in a geographic area's crime or safety level, a change in a vehicle's use, and/or a change in a vehicle's operator (e.g., from sales team member or a C-level executive).

The enterprise level policies can override static policies for controlling operations of vehicle (which may have been set by a manufacturer). A static policy is a policy that does not change over time. For example, a manufacturer may have set a static policy for a vehicle that causes braking when the vehicle is three feet from an external object. This static policy is overridden by an enterprise level policy that causes braking when the vehicle is less than N feet from the external object, where N is any integer other than three. The present solution is not limited to the particulars of this example.

The computing device 106 also facilitates the centralized monitoring and analysis of vehicle related information. The vehicle related information includes, but is not limited to, information indicating vehicle operational states (e.g., on, off, idle, neutral, driving), vehicle operations (e.g., driving forward, driving backwards, turning, wind shield wipers on/off, windows open/closed, trunk open/closed, Air Conditioning (“AC”) on/off, heater on/off, temperature selection, etc.), vehicle maintenance conditions (e.g., oil level, tire level, etc.), seat settings, mirror settings, a vehicle location, and auxiliary device operations (e.g., radio on/off, radio channel selection, display on/off, display content selection, alarm on/off, GPS settings, etc.).

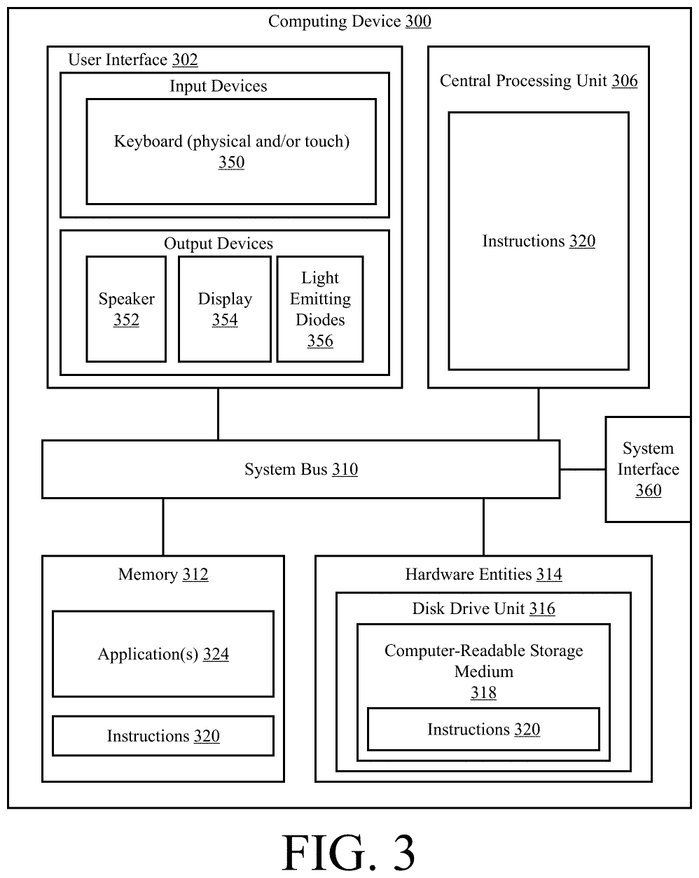

The vehicle related information can be analyzed to determine at least a driving habit of a given driver, seat-belt usage of a given passenger, and/or vehicle maintenance needs, to name just a few examples. A heuristic based technique can be used here for the analysis. Results of the analysis can be used to control and/or limit the behavior of the vehicle(s). For example, the maximum speed of the vehicle(s) is(are) limited, or the vehicle(s) is(are) forced to turn off at a given time of day or when located outside a given geographic area. Additionally or alternatively, the climate controls (e.g., Air Conditioning (“AC”) controls) and radio settings are reset when certain criteria is met (e.g., an expiration of a pre-defined time period, or the vehicle's return to a given facility). An illustrative architecture for the computing device 106 will be discussed below in relation to FIG. 3.

Datastore 108 is configured to store various information and is accessible by the remote computing device. In some scenarios, the datastore 108 comprises a database.

Referring now to FIG. 2, there is provided an illustration of an illustrative system architecture 200 for a vehicle. Vehicles 102₁, . . . , 102_{N} can have the same or similar system architecture as that shown in FIG. 2. Thus, the following discussion of system architecture 200 is sufficient for understanding vehicles 102₁, . . . , 102_{N} of FIG. 1.

As shown in FIG. 2, the system architecture 200 comprises a vehicle on-board computing device 220 connected to a communication device 226. The communication device 226 is configured to facilitate wired and/or wireless communications with external devices (e.g., computing device 106 of FIG. 1). In this regard, the communication device 226 includes a transceiver and an antenna. Any transceiver and antenna can be used herein. For example, a radio transceiver and a radio antenna can be used here.

The communication device 226 allows for telemetry of vehicle related information. The vehicle 200 includes an engine 202 and a plurality of sensors 204-218 measuring various parameters of the engine 202. Still, it should be noted that the sensors, in some examples, comprise an exhaust gas sensor 204, an engine knock sensor 206, an oil pressure sensor 208, an engine temperature sensor 210, a battery voltage sensor 212, an alternator current sensor 214, an engine RPM sensor 216, and a throttle position sensor 218. Other sensors 238, 240, 244-250 are also provided in the vehicle 200. These sensors include a speed sensor 238, an odometer sensor 240, a fuel level sensor 244, an ABS sensor 246, a location sensor 248 (e.g., a GPS device), and a seat belt use sensor 250.

During operations, measurement information is communicated from the sensors 204-218, 238, 240, 244-250 to the on-board computing device 220. The on-board computing device 220 analyzes the engine parameter measurement data from the sensors 204-218, and optionally controls operations of the vehicle based on results of the analysis. For example, the on-board computing device 220 controls braking via a brake controller 232 based on (a) enterprise level policy settings and (b) results of an analysis of engine parameter measurement data received from the sensors 204-218. The brake controller 232 can include a camera. Alternatively or additionally, the following features of the vehicle are controlled: engine speed; vehicle speed; gear of transmission; and/or vehicle steering. The present solution is not limited in this regard. Other operations of the vehicle 200 can be controlled by the on-board computing device 220 via a cruise controller 228, an electronic ignitor 230, a steering controller 234, a window/lock controller 236, and/or a seat controller. Auxiliary devices of the vehicle can be controlled via the auxiliary device controller 254. The auxiliary devices include, but are not limited to, a radio, a display, an SRC (e.g., Bluetooth) enabled device (e.g., a mobile phone) or any other device (e.g., a speed radar) communicatively coupled to the on-board computing device 220.

The seat controller 252 is configured to control the position and settings of the seats in the vehicle. The operating system 222 is configured to support the vehicle on-board computing device's basic functions, such as scheduling tasks, executing application and controlling peripherals. The software agent 224 is a computer program that acts for an enterprise or other software program in a relationship of agency. The operations of software agent 224 will become evident as the discussion progresses. The clock 242 is an electrical device for measuring time.

Vehicle history information is logged in a memory (not shown in FIG. 2) of the on-board computing device 220, or an external datastore (e.g., datastore 108 of FIG. 1). The vehicle history information includes an historical data related to the vehicle, and can be used to determine patterns of vehicle operation or use. A unique identifier is provided for the vehicle. The vehicle history information is stored so as to be associated with the unique vehicle identifier. The unique vehicle identifier can include numbers, letters, symbols or a combination of the same.

Referring now to FIG. 3, there is provided an illustration of an illustrative architecture for a computing device 300. Computing device 106 of FIG. 1 and/or the vehicle on-board computing device 220 of FIG. 2 (is)are the same as or similar to computing device 300. As such, the discussion of computing device 300 is sufficient for understanding these components of system 100.

In some scenarios, the present solution is used in a client-server architecture. Accordingly, the computing device architecture shown in FIG. 3 is sufficient for understanding the particulars of client computing devices and servers.

Computing device 300 may include more or less components than those shown in FIG. 3. However, the components shown are sufficient to disclose an illustrative solution implementing the present solution. The hardware architecture of FIG. 3 represents one implementation of a representative computing device configured to operate a vehicle, as described herein. As such, the computing device 300 of FIG. 3 implements at least a portion of the method(s) described herein.

Some or all components of the computing device 300 can be implemented as hardware, software and/or a combination of hardware and software. The hardware includes, but is not limited to, one or more electronic circuits. The electronic circuits can include, but are not limited to, passive components (e.g., resistors and capacitors) and/or active components (e.g., amplifiers and/or microprocessors). The passive and/or active components can be adapted to, arranged to and/or programmed to perform one or more of the methodologies, procedures, or functions described herein.

As shown in FIG. 3, the computing device 300 comprises a user interface 302, a Central Processing Unit (“CPU”) 306, a system bus 310, a memory 312 connected to and accessible by other portions of computing device 300 through system bus 310, a system interface 360, and hardware entities 314 connected to system bus 310. The user interface can include input devices and output devices, which facilitate user-software interactions for controlling operations of the computing device 300. The input devices include, but are not limited, a physical and/or touch keyboard 350. The input devices can be connected to the computing device 300 via a wired or wireless connection (e.g., a Bluetooth® connection). The output devices include, but are not limited to, a speaker 352, a display 354, and/or light emitting diodes 356. System interface 360 is configured to facilitate wired or wireless communications to and from external devices (e.g., network nodes such as access points, etc.). The external devices can include, but are not limited to, vehicles 102₁, . . . , 102_{N}.

At least some of the hardware entities 314 perform actions involving access to and use of memory 312, which can be a Radom Access Memory (“RAM”), a disk driver and/or a Compact Disc Read Only Memory (“CD-ROM”). Hardware entities 314 can include a disk drive unit 316 comprising a computer-readable storage medium 318 on which is stored one or more sets of instructions 320 (e.g., software code) configured to implement one or more of the methodologies, procedures, or functions described herein. The instructions 320 can also reside, completely or at least partially, within the memory 312 and/or within the CPU 306 during execution thereof by the computing device 300. The memory 312 and the CPU 306 also can constitute machine-readable media. The term “machine-readable media”, as used here, refers to a single medium or multiple media (e.g., a centralized or distributed database, and/or associated caches and servers) that store the one or more sets of instructions 320. The term “machine-readable media”, as used here, also refers to any medium that is capable of storing, encoding or carrying a set of instructions 320 for execution by the computing device 300 and that cause the computing device 300 to perform any one or more of the methodologies of the present disclosure.

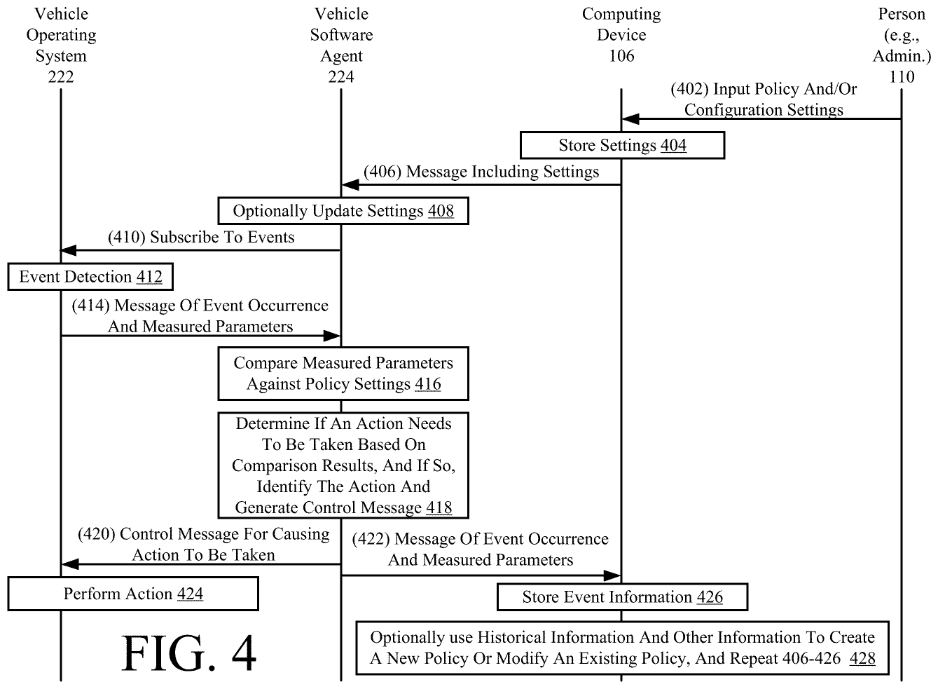

Referring now to FIG. 4, there is provided a message flow for system 100. As shown by 402, a person (e.g., administrator) 110 performs user-software interactions using a computing device 106 to input policy and/or configuration settings. A configuration comprises an arrangement or set-up of hardware and software that make a device (e.g., a vehicle) operate in an intended manner. A configuration setting can include, but is not limited to, values for parameters of one or more pieces of software. The policies include enterprise level policies implementing enterprise-wide requirements, procedures, guidelines and/or goals. Each enterprise level policy contains a policy for one or more vehicles that can be administered by the system 100 using computing device 106. An illustrative policy, in some examples, is to take Y action in response to an occurrence of X event. Additionally, the policy can have multiple stages or severity levels. For example, a policy states that a warning notification must first be provided to the vehicle operator or law enforcement official to resolve the issue (e.g., reduce speed or change path of travel). If the issue is not resolved in a certain amount of time, then user control is overridden and the vehicle OS 222 takes control of the vehicle's operations. The configuration settings include values for vehicle related parameters (e.g., vehicle drive parameters and/or auxiliary device parameters). Any means for inputting information into a computing device can be used herein without limitation. In some scenarios, a physical keyboard or a virtual keyboard is used in this regard.

Next in 404, the computing device 106 performs operations to store the policy and/or configuration settings. This information can be stored in a local memory (e.g., memory 312 of FIG. 3) of the computing device 106 or in a remote datastore (e.g., datastore 108 of FIG. 1). A message including the policy and/or configuration settings is then sent in 406 from the computing device 106 to the vehicle software agent 224 of at least one vehicle (e.g., vehicle 102₁, . . . , and/or 102_{N} of FIG. 1). The message can include, but is not limited to, a push notification. As known in the art, a push notification comprises a message that is sent from one device to another at any time. In response to the message, the vehicle software agent 224 optionally updates 408 the policies and/or configuration settings. This is an optional operation since such updating depends on whether there are any differences with the currently programmed policies/parameters values and those specified in the message. In some scenarios, some or all of the programmed policies/parameters values are replaced or partially modified. Comparison operations can be used to if there are any differences between the currently programmed policies/parameters values and those specified in the message. Alternatively, a flag can be included in the message indicating that a given set of policies/parameters values need to be updated. Also, the update can occur at a time selected based on the total amount of policies/parameters values that need to be updated (e.g., >50 percent update immediately or <50 percent wait for next update message).

In 410, the vehicle software agent 224 subscribes to at least one event (e.g., an action or occurrence of recognized software). The vehicle software agent 224 can select the one or more events for subscription based on the particulars of the policies. This subscription can involve communicating a request for information to the vehicle OS 222 (e.g., pulling) or modifying the behavior of the OS 222 to forward sensor data to the software agent 224 (e.g., hooking). When the vehicle OS 222 detects an event (e.g., the reception of sensor data), it generates and sends a message to the vehicle software agent 224, as shown by 414 (e.g., push notification or hook triggered). This message includes information indicating the event occurrence and sensor data specifying measured parameter values (e.g., speed). At the vehicle software agent 224, the measured parameters are compared against policy settings, as shown by 416. For example, if a policy states that the vehicle should be slowed down when the speed exceeds 65 miles per hour, then the comparison involves comparing the measured speed value to the speed value of 65 miles per hour. Results of this comparison are then used in 418 to determine if an action needs to be taken (e.g., for example, slow down the vehicle speed via brakes or gear shifting). If so, the action is identified (e.g., apply brakes or shift gears) and a control message is generated by the vehicle software agent 224. The control message is sent from the vehicle software agent 224 to the vehicle OS 222 in 420. The vehicle OS 222 controls operations of the vehicle in accordance with the contents of the control message, as shown by 424. For example, the current speed of the vehicle is compared against a pre-defined speed threshold value. If the current speed value exceeds the pre-defined speed threshold value, then an action is taken such as causing the vehicles speed to be reduced to a value below the pre-defined speed threshold value. This reduction in speed overrides any user action to control the vehicles speed. The present solution is not limited to the particulars of this example.

The vehicle software agent 224 notifies the computing device 106 of the event occurrence in 422, and also provides the same with measured parameters. This event information is stored in 426. The event information can be stored in a local memory (e.g., memory 312 of FIG. 3) of the computing device 106 or in a remote datastore (e.g., datastore 108 of FIG. 1). This stored information defines historical information for the vehicle. This historical information and/or other information (e.g., crime statistics) is used in 428 to dynamically create a new policy or modify an existing policy (e.g., periodically or at specified times). Rules can be used to determine when to modify an existing policy or create a new policy. This policy creation or modification can be performed at the vehicle or at the computing device 106. For example, an enterprise level policy is that a fleet of vehicles is not to enter or leave geographic areas identified in a list of geographic areas with a given crime level (obtained from a third party system, such as a police system). If the crime level of a geographic area changes, then the enterprise level policy is dynamically modified to remove or add the geographic area to the list. The present solution is not limited to the particulars of this example.

Additionally or alternatively, the historical information can be used by a machine learning algorithm to learn patterns or behaviors of vehicle use and/or operations. Any machine learning algorithm can be used herein without limitation. For example, one or more of the following machine learning algorithms is employed here: supervised learning; unsupervised learning; semi-supervised learning; and reinforcement learning. These patterns or behaviors can then be used to dynamically create a new policy or modify an existing policy. For example, the historical information can be analyzed using the above machine learning techniques, and the results of such analysis can be used to define or modify an enterprise level policy that when implemented increases efficiency of vehicle operations, optimizes gas usage, extends battery life, or an extends duration between maintenance activities.

Once a new policy has been created or an existing policy has been modified, the operations return to 406 so that the process of 406-426 is repeated. In this way, an event loop is provided in system 100. This event loop facilitates self-healing of system 100. Notably, an override function can be provided such that an administrator can choose to prevent implementation of any created new policy or modification to any existing policy.

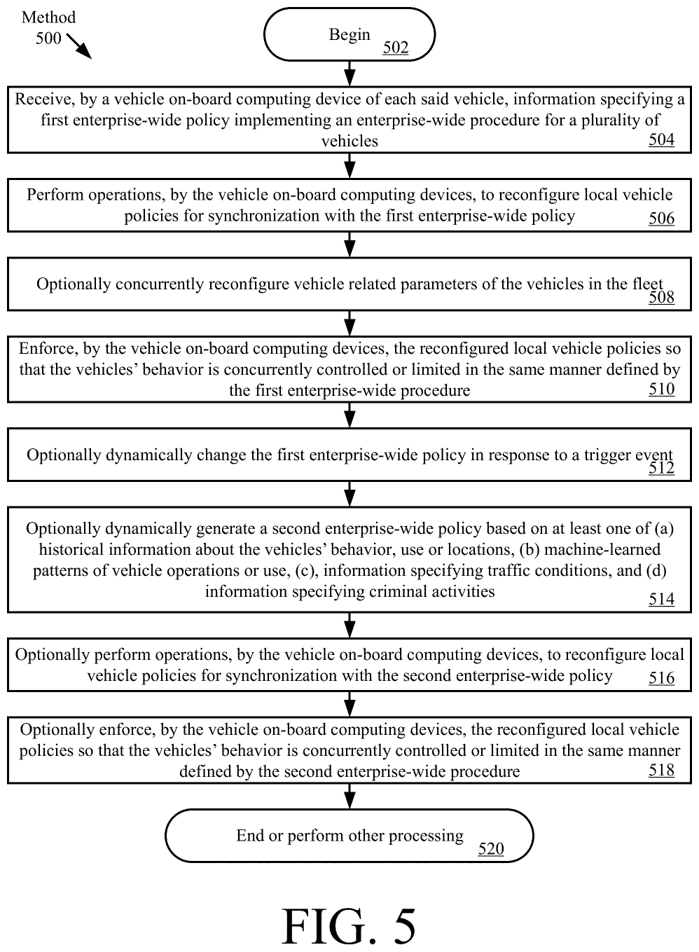

Referring now to FIG. 5, there is provided a flow diagram of an illustrative method 500 for operating a fleet of vehicles (e.g., fleet 112 of FIG. 1) (e.g., which are in the field or deployed for use in the field). Method 500 begins with 502 and continues with 504 where a vehicle on-board computing device (e.g., device 220 of FIG. 2) of each said vehicle (e.g., vehicle 102₁, . . . , 102_{N} of FIG. 1) receives information specifying a first enterprise-wide policy implementing an enterprise-wide procedure for a plurality of vehicles (e.g., no vehicle is to exceed 65 miles per hour and/or leave a certain geographic area). In 506, the vehicle on-board computing devices perform operations to reconfigure local vehicle policies for synchronization with the first enterprise-wide policy. Vehicle related parameters may also be reconfigured for the fleet of vehicles, as shown by 508. The vehicle related parameters comprise vehicle drive parameters and/or auxiliary device parameters. The auxiliary device parameters comprise parameters for a radio, a display, a camera, a location device, or an SRC enable device.

Upon completing 506 or 508, the vehicle on-board computing devices perform operations to enforce the reconfigured local vehicle policies so that the vehicles' behavior is concurrently controlled or limited in the same manner defined by the enterprise-wide procedure. This enforcement can involve: overriding a static policy for controlling operations of a vehicle which was set at a factory; and/or overriding user control of the vehicles. The vehicles' behavior can be controlled or limited based on vehicle related information obtained from a plurality of sensors disposed in the vehicles.

The first enterprise-wide policy can be dynamically changed in response to a trigger event, as shown by 510. The trigger event can include, but is not limited to, an expiration of a period of time, a change in enterprise requirements, a change in enterprise procedures, a change in enterprise guidelines, a change in enterprise goals, a vehicles arrival or return to a given facility, a change in traffic conditions, a change in weather, a change in criminal activity, a change in a geographic area's crime or safety level, a change in a vehicle use, and/or a change in a vehicle operator.

Additionally or alternatively, a second enterprise-wide policy can be dynamically generated based on at least one of (a) historical information about the vehicles' behavior, use or locations, (b) machine-learned patterns of vehicle operations or use, (c), information specifying traffic conditions, and (d) information specifying criminal activities. This dynamic generation can be performed by the vehicle on-board computing device or a remote computing device (e.g., computing device 106 of FIG. 1). In this case, the vehicle on-board computing devices perform operations in 514 and 516 to: reconfigure local vehicle policies for synchronization with the second enterprise-wide policy; and enforce the reconfigured local vehicle policies so that the vehicles' behavior is concurrently controlled or limited in the same manner defined by the second enterprise-wide procedure. Subsequently, 518 is performed where method 500 ends or other processing is involved.

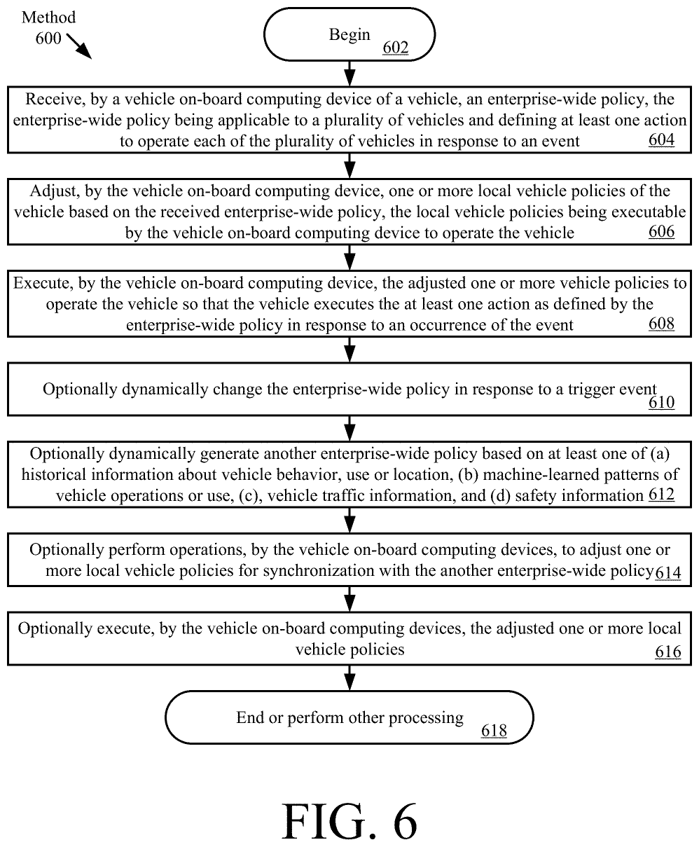

Referring now to FIG. 6, there is provided an illustrative method 600 for operating a vehicle. Method 600 begins with 602 and continues with 604 where a vehicle on-board computing device of the vehicle received an enterprise-wide policy. The enterprise-wide policy is applicable to a plurality of vehicles and defines at least one action to operate each of the plurality of vehicles in response to an event. In 606, the vehicle on-board computing device adjusts one or more local vehicle policies of the vehicle based on the received enterprise-wide policy. The local vehicle policies are executable by the vehicle on-board computing device to operate the vehicle. In 608, the vehicle on-board computing device executes the adjusted one or more vehicle policies to operate the vehicle so that the vehicle executes the at least one action as defined by the enterprise-wide policy in response to an occurrence of the event. This can involve overriding a static policy for controlling operations of the vehicle and/or overriding user control of the vehicle.

In optional 610, the enterprise-wide policy is dynamically changed in response to a trigger event. The trigger event comprises an expiration of a period of time, a change in enterprise requirements, a change in enterprise procedures, a change in enterprise guidelines, a change in enterprise goals, a vehicles arrival or return to a given facility, a change in traffic conditions, a change in weather, a change in criminal activity, a change in a geographic area's crime or safety level, a change in a vehicle use, or a change in a vehicle operator.

In optional 612, another enterprise-wide policy is generated based on at least one of (a) historical information about vehicle behavior, use or location, (b) machine-learned patterns of vehicle operations or use, (c), vehicle traffic information, and (d) safety information. The vehicle on-board computing device then optionally performs operation in 614 to adjust one or more local vehicle polices for synchronization with the another enterprise-wide policy generated in 612. In 616, the vehicle on-board computing device executes the adjusted one or more local vehicle policies. Subsequently, 618 is performed where method 600 ends or other processing is performed.

Although the present solution has been illustrated and described with respect to one or more implementations, equivalent alterations and modifications will occur to others skilled in the art upon the reading and understanding of this specification and the annexed drawings. In addition, while a particular feature of the present solution may have been disclosed with respect to only one of several implementations, such feature may be combined with one or more other features of the other implementations as may be desired and advantageous for any given or particular application. Thus, the breadth and scope of the present solution should not be limited by any of the above described embodiments. Rather, the scope of the present solution should be defined in accordance with the following claims and their equivalents.

1. A method for operating a vehicle, comprising:
receiving, by a vehicle on-board computing device of said vehicle, an enterprise-wide policy, the enterprise-wide policy being applicable to a plurality of vehicles and defining at least one action to operate each of the plurality of vehicles in response to an event;
adjusting, by the vehicle on-board computing device, one or more local vehicle policies of the vehicle based on the received enterprise-wide policy, the local vehicle policies being: locally stored at the vehicle before receipt of the enterprise-wide policy and executable by the vehicle on-board computing device to operate the vehicle; and
executing, by the vehicle on-board computing device, the adjusted one or more local vehicle policies to operate the vehicle so that the vehicle executes the at least one action as defined by the enterprise-wide policy in response to an occurrence of the event.

2. The method according to claim 1, further comprising concurrently reconfiguring vehicle related parameters of multiple vehicles in a fleet of vehicles based on receipt of the enterprise-wide policy by each of the multiple vehicles in the fleet of vehicles.

3. The method according to claim 2, wherein the vehicle related parameters comprise vehicle drive parameters and auxiliary device parameters.

4. The method according to claim 3, wherein the auxiliary device parameters comprise parameters for a radio, a display, a camera, a location device, or a Short Range Communications (“SRC”) enabled device.

5. The method according to claim 1, wherein the enterprise-wide policy is administered by a remote computing device that is configured to communicate with the vehicles.

6. The method according to claim 1, wherein the executing comprises overriding a static policy for controlling operations of the vehicle.

7. The method according to claim 1, wherein the executing comprises overriding user control of the vehicle.

8. The method according to claim 1, further comprising dynamically changing the enterprise-wide policy in response to a trigger event.

9. The method according to claim 8, wherein the trigger event comprises an expiration of a period of time, a change in enterprise requirements, a change in enterprise procedures, a change in enterprise guidelines, a change in enterprise goals, a vehicles arrival or return to a given facility, a change in traffic conditions, a change in weather, a change in criminal activity, a change in a geographic area's crime or safety level, a change in a vehicle use, or a change in a vehicle operator.

10. The method according to claim 1, wherein in the enterprise-wide policy is a first enterprise-wide policy, and the method further comprises generating a second enterprise-wide policy based on at least one of (a) historical information about vehicle behavior, use or location, (b) machine-learned patterns of vehicle operations or use, (c), vehicle traffic information, and (d) safety information.

11. The method according to claim 1, wherein the vehicle behavior is controlled or limited based on vehicle related information obtained from a plurality of vehicle sensors.

12. A system, comprising:
a fleet of vehicles comprising on-board computing devices, each on-board computing device configured to:
receive an enterprise-wide policy that is applicable to a plurality of vehicles and defines at least one action to operate each of the plurality of vehicles in response to an event,
adjust one or more local vehicle policies of a respective vehicle based on the received enterprise-wide policy, the local vehicle policies being: locally stored at the vehicle before receipt of the enterprise-wide policy and executable by the vehicle on-board computing device to operate the vehicle, and
executing the adjusted one or more local vehicle policies to operate the respective vehicle so that the respective vehicle executes the at least one action as defined by the enterprise-wide policy in response to an occurrence of the event.

13. The system of claim 12, wherein vehicle related parameters of multiple vehicles in the fleet of vehicle are concurrently reconfigured based on receipt of the enterprise-wide policy by each of the multiple vehicles in the fleet of vehicles.

14. The system according to claim 13, wherein the vehicle related parameters comprise vehicle drive parameters and auxiliary device parameters.

15. The system according to claim 14, wherein the auxiliary device parameters comprise parameters for a radio, a display, a camera, a location device, or a Short Range Communications (“SRC”) enabled device.

16. The system according to claim 12, wherein the enterprise-wide policy is administered by a remote computing device that is configured to communicate with the vehicles.

17. The system according to claim 12, wherein the executing comprises overriding a static policy for controlling operations of the respective vehicle.

18. The system according to claim 12, wherein the executing comprises overriding user control of the vehicles.

19. The system according to claim 12, wherein the enterprise-wide policy is dynamically changed in response to a trigger event.

20. A system, comprising:
a processor; and
a non-transitory computer-readable storage medium comprising programming instructions that are configured to cause the processor to implement a method for operating a vehicle, wherein the programming instructions comprise instructions to:
receive an enterprise-wide policy that is applicable to a plurality of vehicles and defining at least one action to operate each of the plurality of vehicles in response to an event;
adjust one or more local vehicle policies of the vehicle based on the received enterprise-wide policy, the local vehicle policies being: locally stored at the vehicle before receipt of the enterprise-wide policy and executable by the vehicle on-board computing device to operate the vehicle; and
execute the adjusted one or more local vehicle policies to operate the vehicle so that the vehicle executes the at least one action as defined by the enterprise-wide policy in response to an occurrence of the event.
